(19) United States
(12) Patent Application Publication
(10) Pub. No.: US 2008/0250969 A1
(43) Pub. Date: Oct. 16, 2008

(54) Modified dyes and methods of making the same

(76) Inventors: Sivapackia Ganapathiappan, Los Altos, CA (US); Zhang-Lin Zhou, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/787,528

(22) Filed: Apr. 16, 2007

(51) Int. Cl. C09D 11/02; C09B 67/02

(52) U.S. Cl. 106/31.57; 8/524

(57) ABSTRACT

Modified dyes, inks containing modified dyes, and associates methods of manufacture are described. The modified dyes are made by adding a hydrocarbon chain to the unmodified dyes through a hydroxyl, amine, or phenolic functional group. The modification is accomplished using compounds containing reactive groups selected from acid chlorides or halogenated hydrocarbon chains. The modified dyes provide enhanced water fastness and increased dispersibility of the dyes and associated inks.

### BACKGROUND OF THE INVENTION

Water soluble dyes are commonly used as colorants in ink-jet inks because of their high chroma, brightness, and transparency. Water soluble dyes exhibit vibrant colors because of their high extinction coefficient when solubilized in water. These dyes, however, historically present numerous print durability disadvantages, particularly in the water-based inks dominantly employed in consumer and commercial ink-jet printers. Such dyes are typically water-soluble and consequently exhibit poor print water fastness and poor bleed control when printed next to other colors or subsequently subjected to humid conditions. Humid bleed normally produces hue shifts and decreased print sharpness.

Historically, in order to improve the durability of inks, organic, non-water soluble dyes have been used. Unfortunately, such dyes have lower extinction coefficients and therefore do not provide the desirable color intensity. Pigments have also been used in an attempt to overcome the water fastness challenges associated with the use of traditional water soluble dyes. Unfortunately, pigments also normally have lower extinction coefficients than dyes and generally do not provide as vibrant colors.

Thus, very few dyes are available which provide the desired color intensity associated with water soluble dyes and which can also provide desirable water fastness and dispersibility with polymers. As such, research continues in this area.

### DETAILED DESCRIPTION OF THE PREFERRED EMBODIMENT(S)

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

In describing and claiming the present invention, the following terminology will be used in accordance with the definitions set forth below.

It is noted that, as used herein, the singular forms of “a,” “an,” and “the” include plural referents unless the context clearly dictates otherwise. Thus, for example, reference to “an ink” includes one or more of such inks, reference to “an amount of dyes” includes reference to one or more amounts of dyes, and reference to “the reactive group” includes reference to one or more ink sets.

As used herein, “vehicle” or “liquid vehicle” refers to liquid compositions that can be used to carry colorants to a substrate. Liquid vehicles are well known in the art, and a wide variety of liquid vehicles may be used in accordance with embodiments of the present invention. Such liquid vehicles may include a mixture of a variety of different agents, including without limitation, surfactants, solvents, co-solvents, buffers, biocides, viscosity modifiers, sequestering agents, stabilizing agents, and water. Vehicles can also carry other solids (other than colorants) as part of the vehicle, such as polymers, UV curable materials, plasticizers, latex particulates, etc., in some embodiments.

As used herein, “ink” refers to a single liquid vehicle that contains at least a dye or a pigment, and in accordance with embodiments of the present invention, some inks can include at least two colorants (e.g., two dyes, two pigments, or a dye and a pigment). In accordance with inks of the present invention, such inks include hydrocarbon modified dyes having an ether, ester, or amido group coupling the dye to the hydrocarbon chain.

As used herein, the terms “hydrocarbon chain” and “alkyl chain” are used interchangeably and refer to a branched or unbranched carbon chain that can be either saturated or unsaturated.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 wt % to about 5 wt %” should be interpreted to include not only the explicitly recited values of about 1 wt % to about 5 wt %, but also include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

The present invention is directed to modified dyes, associated methods of manufacture, and ink-jet inks containing the same. The modified dyes of the present invention provide the good chroma and extinction coefficient, normally associated with water soluble dyes, while also providing improved water fastness and compatibility and dispersibility with polymers and organic solvents.

In one aspect of the present invention a modified dye includes an original water soluble dye structure which has attached to at least on hydrocarbon group. The at least one hydrocarbon group is attached via a linkage group of an ether, ester, or an amido group. In one embodiment the modified dye can include multiple hydrocarbon groups attached to the original water soluble dye structure. When more than one hydrocarbon group is attached to the original water soluble dye structure, the linkage groups can be independently selected from ether, ester, or amido groups. The selection of the linkage groups will be dependent on the type of functional group present on the original water soluble dye structure.

In another aspect of the present invention, an ink for ink-jet printing is provided. The ink includes a modified dye having a hydrocarbon chain and either an ether, ester, or an amido group as well as a liquid vehicle.

In yet another aspect of the present invention, a method of producing modified dyes having improved dispersibility and water fastness is provided. The method involves providing a dye having at least one functional group selected from a hydroxyl group, an amino group, or a phenolic group, and reacting the functional group of the dye with a C₂-C₅₀ hydrocarbon chain including a reactive group. In one embodiment, the hydrocarbon chain can be a C₄-C₁₂ chain, or alternatively, a C₆-C₄₀ chain. In other embodiments, the hydrocarbon chain can be a straight chain hydrocarbon, or a branched hydrocarbon. The reactive groups present with the hydrocarbon chains can be either an acid chloride group or a halogen group. The at least one functional group of the dye is reacted with the reactive group of the hydrocarbon chain forming hydrocarbon-modified dye which includes a hydrocarbon chain and an ether, ester, or an amido group. In one embodiment the halogen reactive group on the hydrocarbon chain can be either a chlorine group, a bromine group, or an iodine group.

The modified dyes of the present invention can be made using a single chemical reaction step in which a hydrophobic group (hydrocarbon chain) and/or free radically a polymerizable group (amido group) is added to the dye. Many dyes inherently include a hydroxyl, amino, or phenolic functional group. These functional groups, upon reaction with acid chlorides or halogenated hydrocarbon chains, can be converted to their corresponding ether, ester, or amido groups with hydrocarbon chain. The hydrocarbon chain contributes to the modified dye's water fastness as well as the dye's compatibility and solubility with hydrophobic solvents and polymers which are found in many inks. An example of the generalized reaction scheme for performing the dye modification of either a hydroxyl group or a phenolic group (with only the —OH portion of the phenolic depicted) containing dye is set forth below:

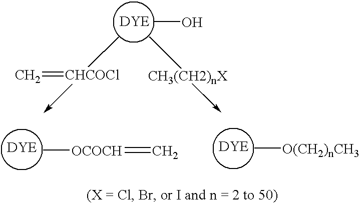

Similarly, an example of the generalized reaction scheme for performing the dye modification of an amine group containing dye is set forth below:

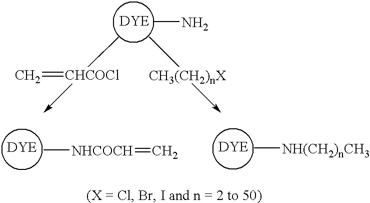

A wide variety of commercially available dyes can be modified in accordance with the present invention so long as they have at least one hydroxyl, amino, or phenolic functional group. Non-limiting examples of dyes which can be modified in accordance with the present invention include Disperse Dyes, Direct Dyes, Acid Dyes, Food Dyes, and the like. Specific examples of dyes include but are not limited to Disperse Red 1, Disperse Blue GLF, Disperse Red 13, Disperse Orange 3, Disperse Orange 13, Reactive Black 5, Reactive Black 9, Reactive Blue 2, Disperse Blue 1, mixtures thereof, and the like. In one embodiment the dye which is modified is a water soluble dye. Modification of water soluble dyes increases the dyes solubility in organic solvents and increases the dyes compatibility of the dye with monomers and increases its ability to be incorporated into polymers.

When the functional group on the dye is an amine group, the modified dye will often contain an amido group. Modified dyes which include an amido group can contain free radically polymerizable groups. The presence of free radically polymerizable functional groups on the dye can increase the dyes ability to be incorporated or polymerized with monomers into polymers. Unmodified dyes tend to precipitate out of solution and have less desirable dispersion characteristics. The modified dyes of the present invention have increased dispersibility characteristics in the polymer matrix. Inks made using the modified dyes of the present invention often have increased dye load capacity because of the compatibility with the polymers as well as with the solvent vehicles. Such dye load increases do not adversely affect the printability of the inks because any phase separation or aggregation of the dye molecules is minimized.

The dyes of the present invention can be incorporated alone or in combination into inks for use in a variety of applications, particularly ink-jet printing. The modified dyes of the present invention can be compatible with most solvents used in the ink arts, whether hydrophobic or hydrophilic. When the modified dyes of the present invention are incorporated into an ink they increase the water fastness of the ink. The modified dyes of the present invention can also be used in combination with un-modified dyes to form inks.

The ink-jet inks prepared with the modified dyes of the present invention can be prepared in an aqueous formulation or liquid vehicle which can include water, cosolvents, surfactants, buffering agents, biocides, sequestering agents, viscosity modifiers, humectants, binders, and/or other known additives. In one aspect of the present invention, the liquid vehicle can comprise from about 70% to about 98% by weight of the ink-jet ink composition. Further, other than the liquids of the vehicle, solids can also be dispersed it the liquid vehicle, such as polymers, photo curable materials, plasticizers, latex particulates, etc.

As described, cosolvents can be included in the ink-jet inks of the present invention. Suitable cosolvents for use in the inks of the present invention include water soluble organic cosolvents, but are not limited to, aliphatic alcohols, aromatic alcohols, diols, glycol ethers, poly(glycol) ethers, lactams, formamides, acetamides, long chain alcohols, ethylene glycol, propylene glycol, diethylene glycols, triethylene glycols, glycerine, dipropylene glycols, glycol butyl ethers, polyethylene glycols, polypropylene glycols, amides, ethers, carboxylic acids, esters, organosulfides, organosulfoxides, sulfones, alcohol derivatives, carbitol, butyl carbitol, cellosolve, ether derivatives, amino alcohols, and ketones. For example, cosolvents can include primary aliphatic alcohols of 30 carbons or less, primary aromatic alcohols of 30 carbons or less, secondary aliphatic alcohols of 30 carbons or less, secondary aromatic alcohols of 30 carbons or less, 1,2-diols of 30 carbons or less, 1,3-diols of 30 carbons or less, 1,5-diols of 30 carbons or less, ethylene glycol alkyl ethers, propylene glycol alkyl ethers, poly(ethylene glycol) alkyl ethers, higher homologs of poly(ethylene glycol) alkyl ethers, poly(propylene glycol) alkyl ethers, higher homologs of poly(propylene glycol) alkyl ethers, lactams, substituted formamides, unsubstituted formamides, substituted acetamides, and unsubstituted acetamides. Specific examples of cosolvents that are preferably employed in the practice of this invention include, but are not limited to, 1,5-pentanediol, 2-pyrrolidone, 2-ethyl-2-hydroxymethyl-1,3-propanediol, diethylene glycol, ethoxylated glycerol, 3-methoxybutanol, 1,3-dimethyl-2-imidazolidinone, or derivatives thereof. Cosolvents can be added to reduce the rate of evaporation of water in the ink to minimize clogging or other properties of the ink such as viscosity, pH, surface tension, optical density, and print quality. The cosolvent concentration can range from about 0 wt % to about 50 wt %, and in one embodiment is from about 15% to about 40% by weight. Multiple cosolvents can also be used, wherein each cosolvent is typically present at from about 2% to about 20% by weight of the ink-jet inks.

Various buffering agents can also be optionally used in the ink-jet inks of the present invention. Typical buffering agents include such pH control solutions as hydroxides of alkali metals and amines, such as lithium hydroxide, sodium hydroxide, potassium hydroxide; citric acid; amines such as triethanolamine, diethanolamine, and dimethylethanolamine. If used, buffering agents typically comprise less than about 10% by weight of the ink-jet inks.

In another aspect of the present invention, various biocides can be used to inhibit growth of undesirable microorganisms. Several non-limiting examples of suitable biocides include benzoate salts, sorbate salts, commercial products such as NUOSEPT (Nudex, Inc., a division of Huls America), UCARCIDE (Union Carbide), VANCIDE (RT Vanderbilt Co.), and PROXEL (ICI Americas) and other known biocides. Typically, such biocides comprise less than about 5% by weight of the ink-jet ink composition and often from about 0.1% to about 0.25% by weight.

In an additional aspect of the present invention, binders can be included which act to secure the dyes on the substrate. Binders suitable for use in the present invention typically have a molecular weight of from about 100 to about 50,000 g/mol. Non-limiting examples include polyester, polyester-melanine, styrene-acrylic acid copolymers, styrene-acrylic acid-alkyl acrylate copolymers, styrene-maleic acid copolymers, styrene-maleic acid-alkyl acrylate copolymers, styrene-methacrylic acid copolymers, styrene-methacrylic acid-alkyl acrylate copolymers, styrene-maleic half ester copolymers, vinyl naphthalene-acrylic acid copolymers, vinyl naphthalene-maleic acid copolymers, and salts thereof.

In one aspect of the present invention, the ink-jet inks can include surfactants. Such surfactants can include standard water-soluble surfactants such as alkyl polyethylene oxides, alkyl phenyl polyethylene oxides, polyethylene oxide (PEO) block copolymers, acetylenic PEO, PEO esters, PEO amines, PEO amides, and dimethicone copolyols. If used, surfactants can be from 0.01% to about 10% by weight of the ink-jet ink composition. Various combinations of nonionic, anionic, and/or amphoteric surfactants can also be used.

### EXAMPLES

The following examples illustrate some embodiments of the invention. However, it is to be understood that the following are only exemplary or illustrative of the application of the principles of the present invention. Numerous modifications and alternative compositions, methods, and systems may be devised by those skilled in the art without departing from the spirit and scope of the present invention. The appended claims are intended to cover such modifications and arrangements. Thus, while the present invention has been described above with particularity, the following Examples provide further detail in connection with what are presently deemed to be the most practical and preferred embodiments of the invention.

### Example 1—Preparation of a Modified Disperse Red Dye in the Acrylate Form

Disperse Red dye from Aldrich is dissolved in dichloromethane and mixed with triethylamine. The mixture is then cooled with ice. After the mixture is cooled, acryloyl chloride is added to the cooled solution and the solution is stirred overnight at ambient temperature. After stirring, the solution is washed with water to remove the hydrochloride salt formed in the reaction. The residual organic layer is then dried over anhydrous sodium sulfate and then filtered. The dichlormethane is removed from the organic layer leaving behind the modified dye with an acrylate group. The related reaction scheme for the above modified dye is set forth below:

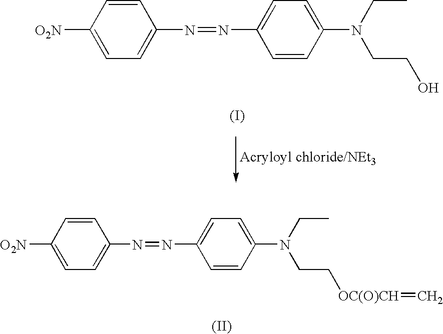

### Example 2—Preparation of a Modified Disperse Blue Dye in the Octylate Form

Disperse Blue dye from Crompton and Knowles is dissolved in dimethylformamide and mixed with potassium carbonate and octyl bromide. The solution is then heated to 130° C. for 13 hours and then at 155° C. for an additional 2 hours. The reaction solution is combined with water and the precipitated dye is dissolved in tetrahydrofuran and precipitated in hexane. The precipitated dye is filtered and dried to obtain the modified dye with an octyl group. The related reaction scheme for the above modified dye preparation is set forth below:

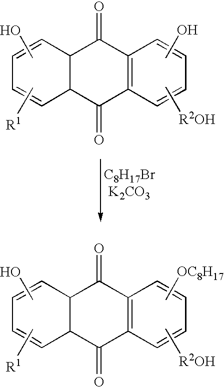

R¹=Chromophoric groups such as short chain alkyl groups e.g. methyl or ethyl groups

R²═(CH₂)ₙ

It is noted that both of the OH groups can be alkylated, depending on the amount of octyl bromide used in the reaction.

### Example 3—Preparation of a Modified Disperse Blue Dye in the Acrylate Form

Disperse Blue dye from Crompton and Knowles is dissolved in dichloromethane and diisopropylethylamine (triethylamine can be substituted for the diisopropylethylamine). The solution is cooled on ice. After cooling, acryloyl chloride is added to the solution and stirred at ambient temperature overnight. The solution is washed with water to remove the hydrochloride salt formed in the reaction. The organic layer of the washed solution is removed and was dried over anhydrous sodium sulfate and filtered. The dichloromethane is removed to obtain the modified dye with the acrylate group. The related reaction scheme is set forth below:

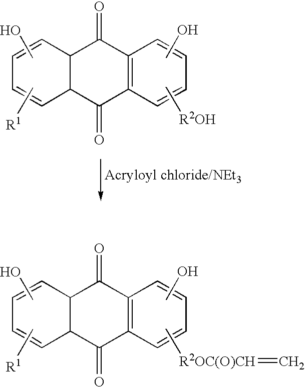

R¹=Chromophoric groups such as short chain alkyl groups e.g. methyl or ethyl groups

R²═(CH₂)ₙ

It is noteworthy that all of the OH groups in the unmodified dye can be converted to acrylic esters if sufficient amounts of acryloyl chloride are used. The greater amount of acryloyl chloride used the higher the number of OH groups concerted to acrylic esters.

### Example 4—Preparation of a Modified Direct Red Dye

A Direct Red dye having a hydroxyl functional group is dissolved in dichloromethane and diisopropylethylamine (triethylamine can be substituted for the diisopropylethylamine). The solution is then cooled on ice. Acryloyl chloride is added to and the solution is stirred at ambient temperature overnight. The solution is then washed with water to remove the hydrochloride salt formed in the reaction. The organic layer of the washed solution is removed and was dried over anhydrous sodium sulfate and filtered. The dichloromethane is removed to obtain the modified dye with the acrylate group.

### Example 5—Preparation of an Acid Blue Modified Dye

An Acid Blue dye having an amine functional group is dissolved in dichloromethane and diisopropylethylamine (triethylamine can be substituted for the diisopropylethylamine). The solution is then cooled on ice, and then, acryloyl chloride is added to and the solution is stirred at ambient temperature overnight. The solution is washed with water to remove the hydrochloride salt formed in the reaction. The organic layer of the washed solution is removed and was dried over anhydrous sodium sulfate and filtered. The dichloromethane is removed to obtain the modified dye with the amido group.

### Example 6—Preparation of a Modified Dye-Based Ink-Jet Ink

A Disperse Red ink is prepared which includes the modified dye of Example 1, in accordance with Table 1, as follows:

TABLE 1
Disperse Red Ink

| Component | Disperse Red 1 (Wt %) |
|---|---|
| 2-pyrrolidone | 1–6% |
| Diethylene glycol | 10–20% |
| 1,5-pentanediol | 1–3% |
| N-methyl-pyrrolidone | 1–5% |
| Biocide | 1–5% |
| Water | Balance |

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the claims.

1. A method of producing modified dyes having improved dispersibility and water fastness, comprising:
providing a dye having at least one functional group selected from a hydroxyl group, an amino group, and a phenolic group; and
reacting said dye with a C₂-C₅₀ hydrocarbon chain including a reactive group selected from an acid chloride and a halogen, wherein the functional group is reacted with the reactive group, thereby forming a hydrocarbon-modified dye which includes a hydrocarbon chain and an ether, ester, or an amido group.

2. The method of claim 1, wherein said dye is a water soluble dye.

3. The method of claim 1, wherein said hydrocarbon-modified dye has increased solubility in organic solvents.

4. The method of claim 1, where said hydrocarbon-modified dye includes an amido group with a hydrocarbon chain.

5. The method of claim 4, wherein said amido group contains a free radical which increases the dyes compatibility with monomers.

6. The method of claim 4, wherein said amido group increases the incorporation of the hydrocarbon-modified dye in polymers when it is polymerized with monomers.

7. The method of claim 6, wherein said increased said amido group increases the dye load capability of the hydrocarbon-modified dye in polymer dispersions and inks.

8. The method of claim 7, wherein said increased dye load does not adversely affect printability of inks containing the hydrocarbon-modified dye.

9. The method of claim 1, wherein said hydrocarbon-modified dye includes an ether or ester group with a hydrocarbon chain.

10. The method of claim 1, wherein said hydrocarbon-modified dye is incorporated into an ink.

11. The method of claim 10, wherein said hydrocarbon-modified dye provides for increased water fastness of the ink.

12. The method of claim 1, wherein the halogen of is selected from chlorine, bromine, and iodine.

13. The method of claim 1, wherein the dye is selected from the group consisting of Disperse Red 1, Disperse Blue GLF, Disperse Red 13, Disperse Orange 3, Disperse Orange 13, Reactive Black 5, Reactive Black 9, Reactive Blue 2, Disperse Blue 1, mixtures thereof.

14. A hydrocarbon modified dye, comprising:
a water soluble dye structure modified with at least one C2-C50 hydrocarbon chain attached thereto through either an ether, ester, or amido group.

15. The modified dye of claim 14, wherein the at least one hydrocarbon chain is a C₄-C₁₂ hydrocarbon chain.

16. The modified dye of claim 14, wherein the at least one hydrocarbon chain is a C₆-C₄₀ hydrocarbon chain.

17. The modified dye of claim 14, wherein the at least one hydrocarbon chain is branched.

18. The modified dye of claim 14, prepared by:
providing an unmodified dye having at least one functional group selected from a hydroxyl group, an amino group, and a phenolic group; and
reacting said unmodified dye with a C₂-C₅₀ hydrocarbon chain including a reactive group selected from an acid chloride and a halogen, wherein the functional group is reacted with the reactive group, thereby forming a modified dye which includes a hydrocarbon chain and an ether, ester, or an amido group.

19. An ink for ink-jet printing, comprising:
a liquid vehicle suitable in ink-jet printing; and
a hydrocarbon modified dye as in claim 14, wherein the hydrocarbon modified dye is more soluble in at least one organic solvent of the liquid vehicle than water.

20. The ink of claim 19, wherein the ink exhibits water fastness when printed on a media substrate that is improved compared to a second ink, said second ink being identical to the ink except that the second ink is replaces the hydrocarbon modified dye with a second dye that is not modified by the hydrocarbon, but which is otherwise identical.
